(19) United States
(12) Patent Application Publication
(10) Pub. No.: US 2013/0283785 A1
(43) Pub. Date: Oct. 31, 2013

(54) Coulter Compressor an exhaust removal driven compressor

(71) Applicant: Timothy E. Coulter, Momence, IL (US)

(72) Inventor: Timothy E. Coulter, Momence, IL (US)

(21) Appl. No.: 13/459,178

(22) Filed: Apr. 28, 2012

(51) Int. Cl. F02B 37/00

(52) U.S. Cl. CPC F02B 37/00
USPC 60/605.1; 60/614

(57) ABSTRACT

A compressor(s), mounted to any combustion engine, removes exhaust. The compressor is constructed of high temperature tolerant materials. The compressor is root, vain, pinwheel or screw design driven by belt, gear, hydraulic motor, crankshaft, camshaft, or pump. This compressor removes exhaust and gases by creation of vacuum on exhaust ports or manifolds. Vacuum is stored and maintained by the motion of the driven compressor. The process starts at the crankshaft, camshaft, or pump, spinning the compressor to create vacuum on one side and boost on the other. As exhaust valves open on any combustion engine of any fuel, exhaust must leave the engine. This compressor removes that exhaust through vacuum, cooling the exhaust, expediting the revolution of the engine and improving the combustion capabilities, increasing horsepower, torque, fuel consumption, cleanliness of exhaust. Using this compressor with any conventional turbo charger will eliminate turbo lag and improve intake levels.

### CROSS REFERENCE TO RELATED APPLICATIONS

This application claims the benefit of U.S. Provisional Application No. 61/639,917, filed on Apr. 28, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

All engines operate off of hot air expansion. These combustion harnessing machines include but are not limited to every known and unknown combustible, rotary, or reciprocal engine system other than a turbine. Because of the nature of the explosions/hot air expansions/combustion that take place within the engine, cogently these combustion engines are not as efficient as they should be. They are restrictive and limited through valving/porting. Hence, the result is unused, wasted energy, known as emissions. In an ideal burning application, there is no unspent fuel/wasted energy. For the foregoing reasons, there is a need for better utilization of the fuel, capturing the complete use of its energy, improving both the proper mixture of the fuel and oxygen and increasing the production of the increased power completely from harnessing the energy, the use of a Coulter compressor which will then allow for less piston exhaust stroke resistance, faster reciprocation of the process and a cleaner burn resulting in a reduction in pollution and an increase in the power/torque to weight ratio. One problem with today's combustion engines is the lack of total use or capture of fuel energy. Today's engine results in lower than achievable power output, unspent fuel leaving the exhaust, resulting in money being lost uselessly. Another problem is the size and weight of today's engines. By increasing the use of the input energy being used, the motor size and weight can be reduced, thus improving overall performance and reducing both friction and resistance.

### BRIEF SUMMARY OF THE INVENTION

Embodiments of the present invention address the above-identified need by providing an apparatus for creating an ideal burning application, reducing emissions by removing exhaust through vacuum, thus cooling the engine, increasing horsepower, torque, lowering fuel consumption, and improving emissions of the exhaust. Decompressing molecules on the engine exhaust side and compressing the molecules on the compression side results in no unspent fuel, clean exhaust emissions. Less engine friction (resistance), and improved engine power and performance.

The general idea of the patent and function of the invention is to produce increased horsepower, torque, fuel economy and reduce engine size, resulting from a more complete combustion process. This device may be used on any combustion engine. Furthermore, the principle process of the exhaust driven compressor is to create vacuum, in turn, decompressing molecules, thus producing a negatively charged environment on the exhaust of any combustion engine. Depending on a four-cycle or two-cycle application, the exhaust valve or valves open, or the exhaust ports, causing the exhaust or spent fuel to be sucked out of the engine through vacuum and may be pushed into a turbo as to create quicker charged air response. This technology may be used in conjunction with a catalytic converter to obtain greater results. The actuation of this device will increase the efficiency of the stroke and reduce piston friction, thus improving the rotation of the reciprocal combustion piston engine. This device may be used on rotary engines as well, to improve the combustion of the rotary through its travel and increase its potential. This exhaust compressor receives its revolutions from the engine's rotation and size based on the desired cfm of the combustion engine. This exhaust driven compressor's rotation can be spun using any one of the following; belts, gears, chains, or hydraulic motors and pumps from either cam or crank. It may be electronically, or mechanically controlled, with a valving or bypass system to regulate its desired application or performance.

### BRIEF DESCRIPTION OF THE SEVERAL VIEWS OF THE DRAWING

FIG. 1 shows a simple side view and the basic travel of the direction of energy of a naturally aspirated standard engine with dual overhead cams.

FIG. 2 shows a generic rotary screw or vain blower Coulter compressor design, as pitch, rotation, and size may vary on application.

FIG. 3 shows a generic pinwheel Coulter compressor design, as pitch, rotation, size and location may vary on application.

FIG. 4 shows a sidecut view of a single cylinder reciprocal piston engine with a crank driven screw rotary or vain drive Coulter compressor and its travel of energy, feeding a standard turbo ran through an intercooler, back to the intake.

FIG. 5 shows a simple reciprocating piston engine with a Coulter compressor and its travel of energy; a side view built into the engine head (generic design).

FIG. 6 shows a simple sidecut view of a reciprocating piston engine's flow of energy with a crank-driven Coulter compressor on the exhaust, feeding a turbo into a standard rotary screw driven, crank driven or vain supercharger.

FIG. 7 shows a reciprocating piston's flow of energy and side view with a cam driven Coulter compressor (exhaust) and a cam driven, rotary screw standard supercharger (intake).

FIG. 8 shows a reciprocating piston engine's flow of energy with a cam driven pinwheel style Coulter compressor.

FIG. 9 shows a side cut view of a naturally aspirated reciprocating piston engine's flow of energy with a pinwheel style Coulter compressor (exhaust) application driven by crank or cam.

### DETAILED DESCRIPTION OF THE INVENTION

The present invention will be described with reference to illustrative embodiments. For this reason, numerous modifications can be made to these embodiments and the results will still come within the scone of the invention. No limitations with respect to the specific embodiments described herein are intended or should be inferred. The generic figures show the benefit, transfer, and value of the energy displaced by the Coulter compressor.

The term “compressor” as used herein is intended to encompass some of the functions, locations, and generic designs of the Coulter compressor.

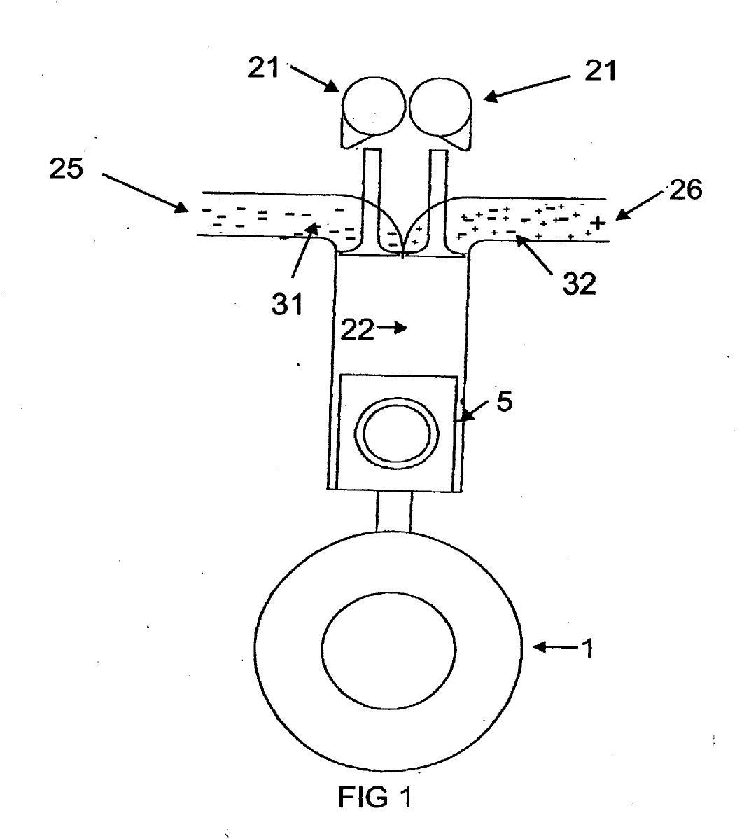

FIG. 1. shows a reciprocating naturally aspirated energy flow in a dual overhead cam engine with its standard operating pressures. It shows 1 a standard crankshaft, 5 is a piston, 22 shows a cylinder, 25 shows a negatively charged intake, 26 shows a mixed charge exhaust flow, 21 demonstrates overhead cams that actuate the valves and the timing of the engine, 31 shows negative symbols representing negatively charged air, 32 shows a random pattern plus and minus representing normal naturally aspirated flow.

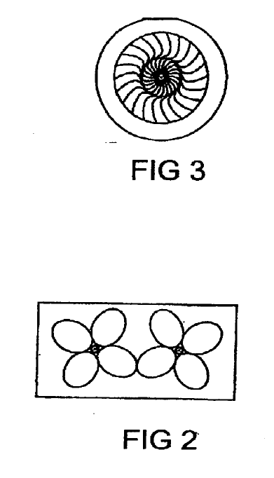

FIG. 2 demonstrates a generic side view of a rotary lobe vain or screw drive Coulter compressor as pitch and style will vary.

FIG. 3. shows a generic side view of a pinwheel style compressor as pitch and size will vary.

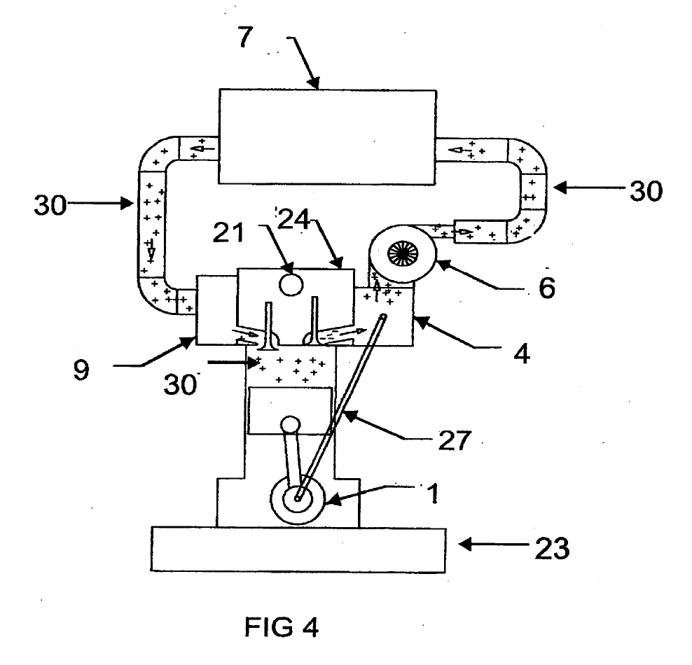

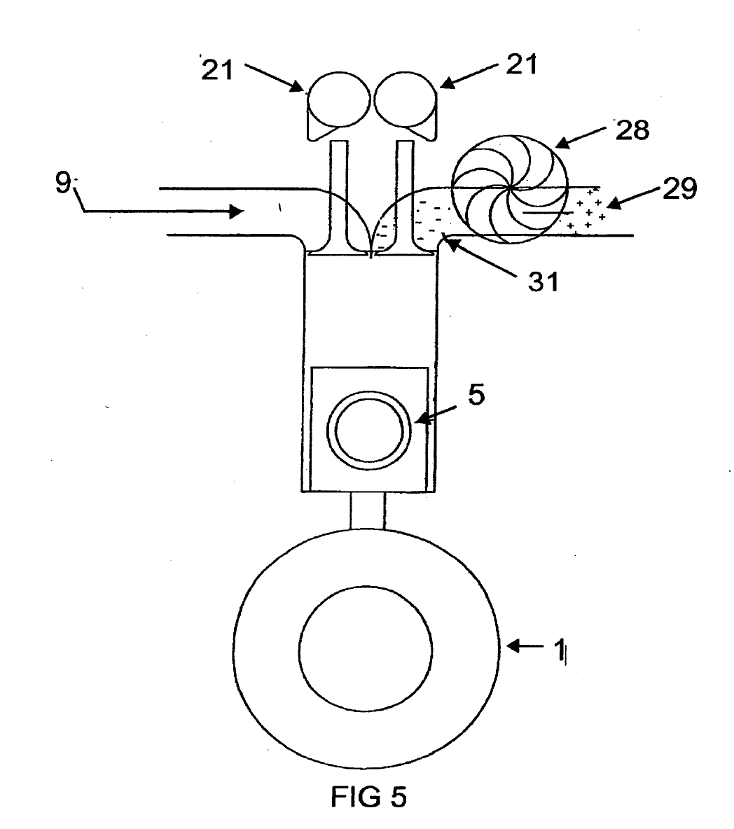

FIG. 4 shows a reciprocating piston engine with a rotary, vain or root style exhaust 4 compressor with a 6 standard turbo, 7 air-to-air after-cooled, cooling the charged air, 9 positively charged intake manifold, 21 overhead cam, 24 cylinder head, 27 a belt chain, or gear driven system from the 1 crank to the 4 compressor, 23 oil pan of the engine, 30 shows positive symbols representing stacked air molecules.

FIG. 5 shows a typical engine 1 crank shaft, 5 a piston, 21 overhead cam that drives 28 the generic position of a internal head pinwheel style compressor and the flow of energy, 9 a standard side intake, negatively charged, 29 positively charged accelerated gas particles 31 shows negative symbols, demonstrating negatively charged vacuum waiting to unload the cylinder in the exhaust stroke.

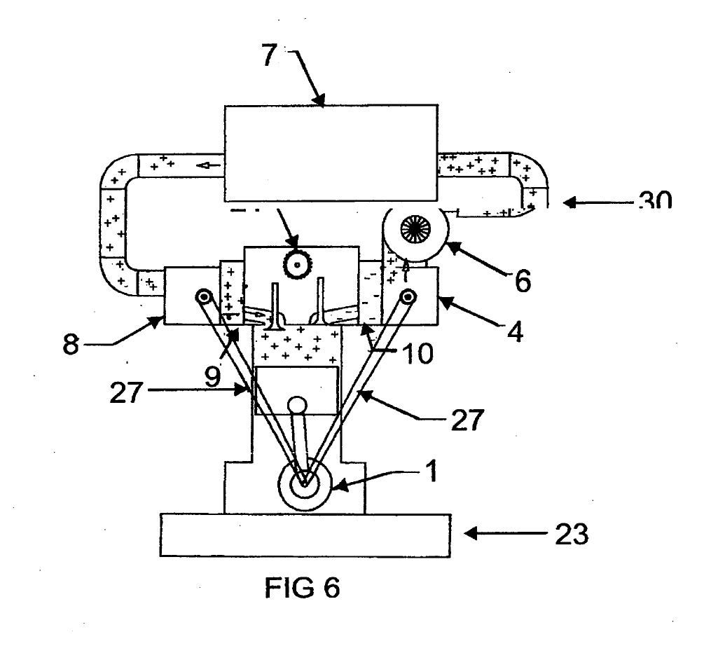

FIG. 6 shows a 1 crank driven 8 standard super charger drawing positively charged cool air from the 7 air-to-air cooler being fed by a 4 compressor driving a 6 standard turbo, 10 developed or produced vacuum or negatively charged air post exhaust valve pre-compressor, 9 positively charged air post-supercharger, 27 belt-chain or gear driven system connecting the 1 crank to the 8 supercharger and 4 compressor, 23 oil pan, 1 engine crank shaft driving 4 a square root, vane style exhaust compressor with a typical 6 stacked turbo.

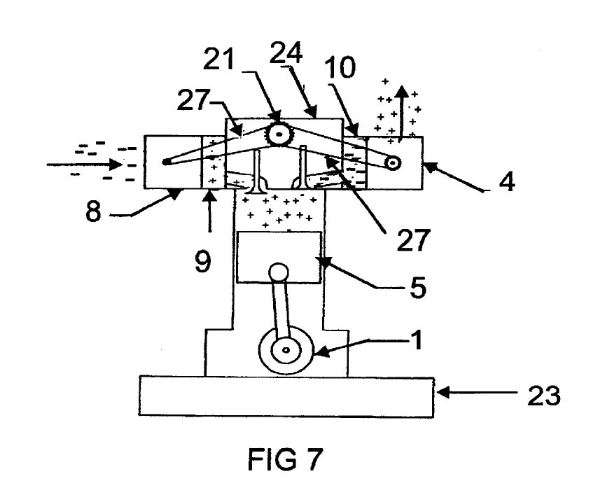

FIG. 7 shows a reciprocating piston engine with a 1 crank, 5 piston, 23 oil pan, 21 cam that drives the 8 standard supercharger drawing vacuum and charging the intake filling the cylinder on a compression stroke 4 root style compressor creating vacuum and compressing, pumping out hot exhaust, 9 positively charged air on the intake side filling the cylinder, 10 demonstrating a negatively charged or vacuum on the exhaust side of any combustion engine waiting to evacuate the cylinder reducing friction and tenure c, 24 cylinder head, 27 belt chain or Rear-driven cam driven blower system.

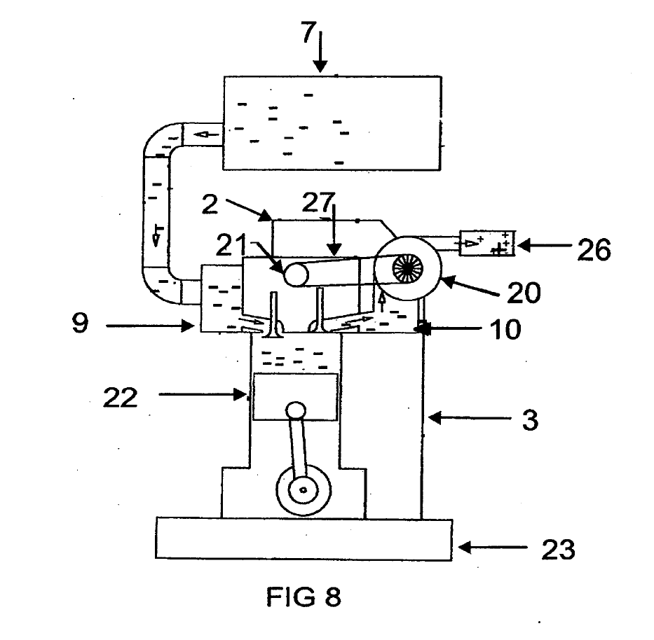

FIG. 8 shows a naturally aspirated reciprocating piston engine with a 20 pinwheel style Coulter compressor, 10 negatively charged vacuumed exhaust, 27 belt chain or gear driven system from the 21 cam to the 20 compressor, 7 air cleaner, 9 vacuum flow of air energy 2 oil supply line, 3 oil return, 22 generic cylinder 26 demonstrates forced, compressed exhaust flowing out of the compressor 23 oil pan.

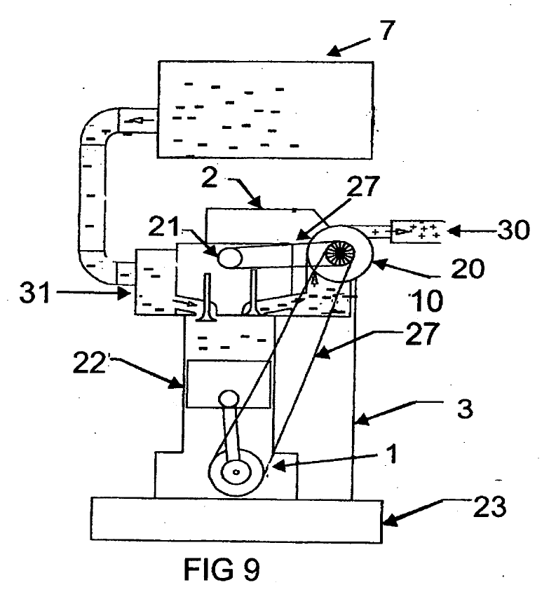

FIG. 9 shows a naturally aspirated reciprocating piston engine with a 20 pinwheel style compressor 10 negatively charged exhaust, 27 belt chain or gear driven system from the 1, crank or 21 cam to the 27 belt chain or gear driven system to the 20 compressor, 7 air cooler, 2 oil supply line, 3 oil return, 23 oil pan, 30 shows compressed molecules positively charged exhaust, 31 demonstrates a negatively naturally aspirated air intake manifold with the intake valve open, flowing into the cylinder.

### DESCRIPTION OF PREFERRED EMBODIMENTS

Here in set forth, be it known: this patented custom personal/commercial exhaust compressor located on any and all moving crafts, machines, vehicles manned and unmanned, trains, tractors, heavy equipment, including mining and construction, shall be protected through the treaties of the countries of the world having entered said. Be it included in the embodiments of this patent the likeness of any similar said devices for use in all private, commercial, on and off road use on land, air, water, or the like are expressly forbidden without license. It will be most obvious to those possessing skill in these technological arts that various changes may be made in the above mentioned, described embodiments. However, the scope of this discovery/invention should be determined by the following claims.

What is claimed is:

1. A Coulter compressor, located post-exhaust port or valve, on any part of the motor, attached to or affixed inside the head, or remote, that is a fixed device with a driven internal rotating assembly, and can be different sizes and shapes, used singularly or sequentially to accomplish desired applications, fully comprised of known or unknown high temperature tolerant materials, including but not limited to steel, brass, copper, titanium, cobalt, composite, ceramic coated and other materials, or any combination of aforementioned high temperature tolerant materials, that gains its rotation from the rotation of the combustion engine that it is located on and through the internal rotation, decompressed exhaust molecules, vacuum, and compressed exhaust molecules, boost, are created simultaneously.

2. A Coulter compressor in claim 1, wherein the compressor can be retrofitted to any existing or newly created combustion engine, two-cycle, four-cycle, or rotary engine of any amount of cylinders, strokes, or rotors of any usable application; i.e. racing, marine, commercial, industrial, military, conventional applications, and any other application.

3. A Coulter compressor in claim 1 or 2, wherein exhaust is removed, reducing both friction and engine cylinder temperature, thus allowing for better combustion charge.

4. A Coulter compressor as in any preceding claim, wherein, the compressor shall be used to improve any combustion engine requiring any type of fuel or dual fuels.

5. A Coulter compressor as in any preceding claim, wherein, the compressor works in conjunction with factory engines to improve fuel economy.

6. A Coulter compressor in any one of claims 1, 2, 3, and 4, wherein the compressor works in conjunction with factory engines to produce increased horsepower.

7. A Coulter compressor in any one of claims 1, 2, 3, and 4, wherein the compressor works in conjunction with factory engines to produce increased torque.

8. A Coulter compressor in any one of claims 1, 2, 3, and 4, wherein the compressor works in conjunction with factory engines to produce improved power and rotation throughout the rpm range.

9. A Coulter compressor in any preceding claims, wherein the compressor, through its rotation, institutes the presence of produced vacuum and decompressed molecules or negatively charged exhaust/air in the exhaust port or manifold, allowing more volume and faster transfer during exhaust valve or port duration.

10. A Coulter compressor in any preceding claims, wherein the now trapped remaining vacuum in the cylinder, created by the compressor, allows for more intake air and fuel to fill the cylinder than under normal combustion engines that are naturally aspirated, supercharged, or turbocharged; due to the vacuum at the time the exhaust valve opens, the gases are sucked out as opposed to being pushed out by the piston or rotor (rotary motor applications) and this creates reduced friction on the piston.

11. A Coulter compressor in any preceding claims, wherein the compressor, through the presence of produced decompressed molecules and vacuum or negative charge, reduces exhaust temperatures, bringing the cylinder, the head, and the valves to lower operating temperatures, allowing increased engine loads and longevity of engine life by reducing valve, valves, piston, pistons, head, heads, cylinder, cylinders, and whole engine temperatures.

12. A Coulter compressor in any preceding claims, wherein through the presence of produced vacuum or negative charge at the exhaust puts the combustion engine at its limitation, meaning that it cannot go any further than the charged intake and vacuumed/vacated exhaust.

13. A Coulter compressor in any preceding claims, wherein the compressor negatively charges (vacates) the exhaust and, in conjunction, through known means, either a supercharger(s) or turbo(s) positively charge the intake, is the precibus and the balance and the limit of the combustion engine.

14. A Coulter compressor in claim 13, wherein the compressor sucks out spent fuel, forcing it into a turbo which then provides positively charged air, is the positive and the negative flow balance to the engine.

15. A Coulter compressor in any preceding claims, wherein the compressor is lubricated from the engine, an external oiler system, or a self-contained lubrication system.

16. A Coulter compressor in any preceding claims, wherein the compressor will decrease pollution on the expulsion side or compressed molecule, boost side of the compressor, thus, increase or produce tremendous exhaust temperatures and pressures, which will in turn, burn any unspent fuel and could also further push through and increase the temperature of a catalytic convertor or other pollution device, ultimately decreasing the amount of leftover fuel and providing a better, cleaner, and more efficient burn and improving overall emissions.

17. A Coulter compressor in any preceding claims, wherein the compressor may be liquid, oil, or air cooled to enhance performance and wear in and out.

18. An internal or external valve or a loop on the Coulter compressor, that senses, through sensor(s), the desired vacuum, boost and/or temperature, and can be spring-loaded, mechanically activated preset, adjustable, or ECM-controlled electronically through servo that is an adjustable system that rolls over by equalizing, depleting, or recycling exhaust gases.
